(19) United States
(12) Patent Application Publication
(10) Pub. No.: US 2009/0303075 A1
(43) Pub. Date: Dec. 10, 2009

(54) METHOD AND APPARATUS FOR SETTING THE STATE OF OPERATION OF AN APPLIANCE

(75) Inventors: Martijn Spit, Eindhoven (NL); Thomas Gerardus Martinus De Wildt, Eindhoven (NL); Aleksandar Ostojic, Eindhoven (NL); Boris Djapic, Eindhoven (NL); Vincent Isidorus Clemens Rikkink, Eindhoven (NL); Peter Tjin Sjoe Kong Tsang, Eindhoven (NL); Hendrikus Gerardus Van Horck, Eindhoven (NL); Paulus Joannes Hieltjes, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/296,688

(22) PCT Filed: Apr. 5, 2007
(86) PCT No.: PCT/IB2007/051218

§ 371 Date: Oct. 10, 2008

(30) Foreign Application Priority Data
Apr. 11, 2006 (EP) 06112506.8

(51) Int. Cl. G05B 19/02

(52) U.S. Cl. 340/825.22

(57) ABSTRACT

An apparatus for setting the state of operation of an appliance (1) includes a system (10) for supplying at least one control signal for adjusting an operating parameter of the appliance (1), a memory device (11) for storing data corresponding to control signal values defining a first state of operation of the appliance (1), an interface (4,5,14) for receiving at least one input signal corresponding to a desired adjustment of at least one operating parameter of the appliance, and a controller (10) for converting values of the input signal to at least one value of at least one of the control signals for adjusting an operating parameter of the appliance and for supplying the control signals at the values defining the first state of operation in response to a trigger. The apparatus further includes a system for generating the trigger after detecting an absence at the interface (4,5,14) of any input signals corresponding to a desired adjustment of at least one operating parameter of the appliance.

The invention relates to an apparatus for setting the state of operation of an appliance, including:

a system for supplying at least one control signal for adjusting an operating parameter of the appliance,

a memory device for storing data corresponding to control signal values defining a first state of operation of the appliance,

an interface for receiving at least one input signal corresponding to a desired adjustment of at least one operating parameter of the appliance, and

a controller for converting values of the input signal to at least one value of at least one of the control signals for adjusting an operating parameter of the appliance and for supplying the control signals at the values defining the first state of operation in response to a trigger.

The invention also relates to a user-adjustable appliance comprising an apparatus for setting the state of operation of the appliance.

The invention also relates to a method of setting the state of operation of an appliance, including:

receiving an input signal corresponding to a desired adjustment of at least one operating parameter of the appliance,

supplying at least one control signal to at least one component of the appliance at respective values obtained by converting values of the received input signal, so as to adjust at least one operating parameter of the appliance,

supplying at least one control signal at pre-determined values defining a first state of operation of the appliance to the components of the appliance, so as to re-adjust the operating parameters of the appliance.

The invention also relates to a computer program.

Examples of such an apparatus, method and appliance are known. EP-B1-1 141 795 discloses a vehicle management system comprising a plurality of devices. A portable controller has a processor, a memory for storing control information and a switching element for controlling the transfer of control information between the portable controller and the device. In a “receiving mode”, the processor receives control information from the device and stores the control information in the memory. Typically, the device will have been configured by a user to reflect his or her preferences before entering the receiving mode and the control information transferred identifies these preferences. In the “transmitting mode”, the processor sends the control information from the memory of the portable controller to the system. The control information identifies the user's preferences and the system automatically re-configures its associated devices to reflect these preferences. For some applications it would be desirable for the device to be aware of when the user no longer requires it to be configured to his or her preferences, for example when the user leaves the device. The device is able to check whether the portable controller is within a specified range of the device. When the user and portable device move outside the range, the device could automatically reconfigure to the default settings or switch off.

A problem of the known device is that it is unsuitable for use for demonstration purposes, since it requires that a user be provided with a personal portable controller.

It is an object of the invention to provide an apparatus, appliance, method and computer program of the types mentioned in the opening paragraphs that allow the appliance to operate as much as possible in a state regarded as appropriate under general circumstances, and that also allow trial use to determine the effect on the appliance of desired settings deviating from those regarded as appropriate.

This object is achieved by the apparatus according to the invention, which is characterized by including a system for generating the trigger after detecting an absence at the interface of any input signals corresponding to a desired adjustment of at least one operating parameter of the appliance.

Because the apparatus includes a memory device for storing data corresponding to control signal values defining a first state of operation of the appliance, it is possible to store control signal values corresponding to a first state regarded as optimum under general circumstances. Because the system includes a controller for supplying the control signals at the stored values defining the first state of operation in response to a trigger, it is possible to automate the return to the first state, ensuring that the appliance operates as much as possible in a state regarded as optimum under general circumstances. Because the apparatus includes a system for generating the trigger, it is not dependent on an operator for returning the appliance to the first state of operation. Because the apparatus includes a system for generating the trigger after detecting an absence at the interface of any input signals corresponding to a desired adjustment of at least one operating parameter of the appliance, the supply of the control signals at the values corresponding to the first state is independent on a specific signal from a specific control device. Instead it is configured to supply the control signals at the stored values corresponding to the first state of operation only in response to an absence of any input signal corresponding to a desired adjustment for supplying the control signals at the stored values corresponding to the first state of operation. Trial adjustments are nevertheless possible.

In an embodiment, the system for generating the trigger includes a timer and is configured to produce the trigger only upon detecting that a time interval length monitored by the timer has exceeded a reference value.

This embodiment takes account of situations where the effect of adjustments cannot immediately be ascertained, so that some time will be allowed to lapse before any input signals corresponding to a desired further adjustment is provided through the interface.

An embodiment of the apparatus is configured to re-set the timer to an initial value upon detecting receipt through the interface of an input signal corresponding to a desired adjustment of at least one operating parameter of the appliance.

Thus, gradual adjustments can be made without frequent oscillations between the first state and an adjusted state corresponding to the desired adjusted operating parameters.

An embodiment of the apparatus includes a control apparatus including at least one component for manipulation by a user and arranged to generate at least one of the input signals corresponding to a desired adjustment of at least one operating parameter of the appliance in accordance with a manipulation of the at least one component by a user.

Thus, the apparatus allows for direct trial use by a user, in particular to form subjective judgments of the effects of adjusted operating parameters on the functioning of the appliance being operated.

An embodiment of the apparatus includes an interface for receiving a pre-determined command, wherein the apparatus is configured to disable, in reaction to the pre-determined command, the supply of control signals at the stored values corresponding to the first state of operation in response to the trigger.

Thus, the apparatus can be used in a mode allowing any of several different users to evaluate the operation of the appliance with adjusted parameters, but also in a mode in which the apparatus is permanently adapted to a particular set of circumstances or a particular user's preferences. The first mode is advantageous for use in shops or at exhibitions, etc. where the appliance and the apparatus for setting its state of operations are to be demonstrated. The second mode is advantageous for use after delivery of the appliance and apparatus to a particular user.

According to another aspect, the user-adjustable appliance according to the invention includes an apparatus according to the invention.

According to another aspect, the method of setting the state of operation of an appliance according to the invention is characterized in that the step of supplying at least one control signal at pre-determined values defining the first state of operation of the appliance is carried out after a time interval commencing at receipt of the input signal corresponding to the desired adjustment, has elapsed.

Thus, because at least one control signal is supplied at pre-determined values corresponding to a first state of operation of the appliance to the components of the appliance, so as to re-adjust the operating parameters of the appliance, it can be returned to an operating state regarded a priori as the optimal operating state. Because the step of supplying the control signal(s) at the pre-determined values defining the first state is carried out automatically after a time interval commencing at receipt of the input signal corresponding to the desired adjustment has elapsed, no further external input is required. Trial adjustments are possible by means of the input signal corresponding to the desired adjustment.

In an embodiment, the step of supplying the control signal(s) at pre-determined values is only carried out if no further input signal corresponding to the desired adjustment is received within the time interval.

Thus, frequent changes between the first state of operation and states corresponding to the adjusted operating parameters are prevented.

According to another aspect of the invention, there is provided a computer program, including a set of instructions capable, when incorporated in a machine-readable medium, of causing a system having information processing capabilities to perform a method according to the invention and/or to operate as an apparatus according to the invention.

The invention will be explained in further detail with reference to the accompanying drawings, in which:

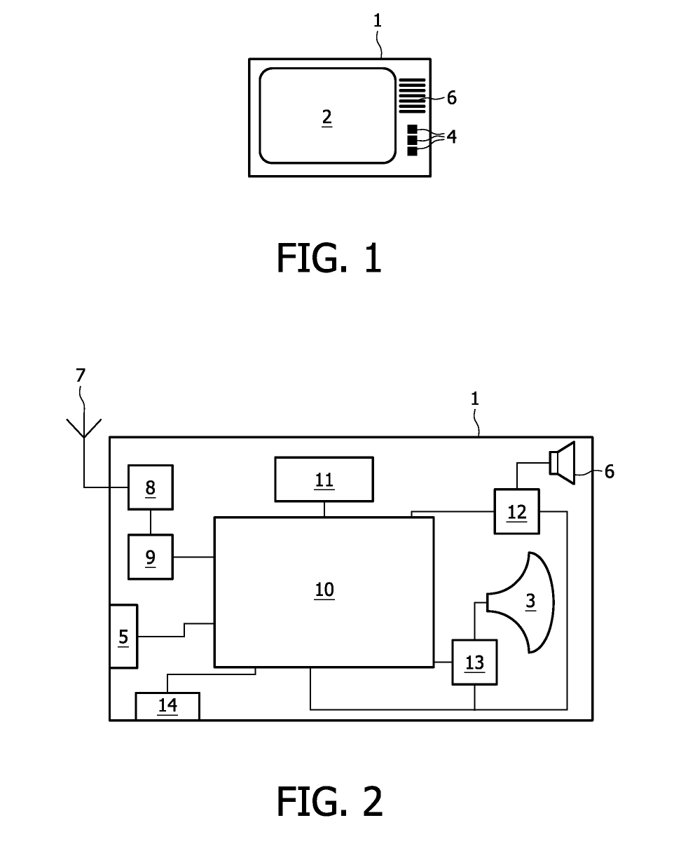

FIG. 1 is a diagrammatic front view of a television set; and

FIG. 2 is a schematic view of selected components of the television set.

A television set 1 is used herein as an example of an appliance of which the state of operation is to be set. The technique outlined herein is, however, equally suitable for application to other appliances, including audiovisual equipment in general or other types of electronically controlled equipment, such as personal computers, telephone hand-sets, personal digital assistants, equipment on board a vehicle, etc. In all cases, it involves providing control signals setting values of operating parameters that define at least partially a state of operation of the appliance. Examples of operating parameters include those varying continuously on a scale, such as the desired temperature in case of a climate control system, or the volume in case of an audio system. Other operating parameters may be values in a set, such as which page in a menu to display on a screen, whether or not a picture is overlaid on a main screen image, the function enacted when a multi-functional key of a device is pressed, etc.

The television set 1 includes a screen 2, comprised in a Cathode Ray Tube (CRT) 3 (FIG. 2). It further includes keys 4 (FIG. 1) included in a control panel 5 (shown schematically in FIG. 2). Sound is provided by a loudspeaker 6.

Selected components of the television set 1 include an antenna 7, a tuner 8 and a demodulator 9. The television set 1 is further provided with a processing device 10 of a type known as a home entertainment engine. The processing device is connected to a memory module 11 via an interface (not shown). The processing device 10 includes a video input interface for receiving the demodulated television signal from the demodulator. An audio output interface (not shown) provides an audio signal to an audio amplifier 12, which drives the loud speaker 6. The processing device 10 includes a module (not shown) for providing an On-Screen-Display (OSD) and a mixer (not shown) for providing an output video signal. That signal is an analogue signal, which is provided to a driver 13 for the CRT 3.

Operating parameters that determine the state of operation of the television set 1 include the brightness and contrast of display of the CRT 3, which are set by providing the appropriate signals to the CRT driver 13. Other operating parameters include the balance, volume and equalization of the audio system, which are set by providing appropriate signals to the audio amplifier 12. Other operating parameters include whether a menu is generated by the OSD module, its dimensions, and the type of content to be displayed therein. These operating parameters are set by appropriate commands to the OSD module and mixer within the processing device 10, under the control of a RISC microprocessor unit (not shown) incorporated in the processing device 10. In effect, the microprocessor unit supplies the control signal for adjusting the relevant operating parameter of the television set 1 in order to determine its state of operation.

The processing device 10 is provided with an interface to the control panel 5, from which it can receive input signals corresponding to desired adjustments of at least one operating parameter, for example, the volume, whether to display a menu over the video image, the menu page to be displayed, etc. The processing device 10 is also provided with an interface to an infrared receiver 14. Together, these parts form an interface for receiving an input signal corresponding to desired adjustments of one or more operating parameters from an infra-red remote control device (not shown).

The television set 1 is operable in a mode for demonstration of the television set 1 in a shop. In one embodiment, the television set 1 enters this mode in response to an instruction provided by means of the control panel 5 or via the infrared receiver 14. In another embodiment the mode is pre-set at manufacture, e.g. by means of appropriate jumper settings on a printed circuit board. In another variant the mode for demonstration in a shop is entered by means of an instruction received through a network interface (not shown) over a network, such as the Internet.

At least when in the mode for demonstration of the television set 1 in a shop, a set of data representative of control signal values defining a first state of operation of the appliance is maintained in storage in the memory module 11. The data may correspond to the actual control signal values or to input signal values that would result in the values of the control signals for operating the television set 1 in the first state. It is noted that, where reference is made to a definition of a state, this may and will generally imply that a sub-set comprising fewer than all operating parameters characterizing the operation of the appliance assumes a particular set of values. Where, for example, the volume of the sound emitted by the loudspeaker 6 does not belong to the definition of the first state, the television set 1 will be regarded as being in the first state at any value of the amplification.

The set of control signal values defining the first state of operation of the television set 1 are chosen to result in an optimal performance of the television set 1 as assessed by the average user in an average shop environment. Thus, the television set 1 is demonstrated to its best advantage.

To allow a potential buyer of the television set to assess the effect of different settings, the processing device 10 is programmed to respond to input signals corresponding to a desired adjustment of at least one operating parameter of the appliance received from the user via the control panel 5 or the infra-red receiver 14. The processing device 10 translates the received values of the input signal to at least one value of at least one of the control signals for adjusting an operating parameter of the television set 1.

A software module implementing the mode for demonstration of the television set 1 in a shop includes a timing mechanism, using the system time provided by a clock (not shown) associated with the processing device 10, for example. The software module includes instructions configuring the processing device 10 to re-set the timer to zero upon detecting receipt through the interface of an input signal corresponding to a desired adjustment of at least one operating parameter of the appliance. This is done continually.

When the time interval length monitored by the timer has exceeded a reference value, this triggers the processing device 10 to retrieve the data representative of control signal values defining the first state of operation from the memory module 11, and to supply the control signals at the retrieved values to the various components of the television set 1. These components include modules within the processing device 10 itself. As a consequence, the television set 1 automatically returns to the settings that are optimal for the average shopping environment when it has been determined that more than a certain period of time has elapsed since the last adjustment of the settings was made by a user. Appropriate values for the time interval that is allowed to pass before the television set 1 is set to the first state are in the order of minutes, for example a value between one and ten minutes, such as four minutes.

The television set 1 can be set to a different mode than the mode for demonstration of the television set 1 in a shop. The television set 1 leaves this mode upon receipt of a pre-determined command. The processing device 10 is programmed to disable, in response to the pre-determined command, the supply of control signals at the stored values corresponding to the first state of operation in response to the trigger from the timer. It may be that the timer is no longer used to monitor the time interval that has elapsed since the last receipt of an input signal corresponding to a desired adjustment. In another embodiment, the timer does not trigger the supply of control signals at the values corresponding to the first state any longer. In one embodiment, the departure from the mode for demonstration in a shop is irreversible. In another embodiment, a further pre-determined command returns the television set 1 to this mode.

The pre-determined command may be provided in one of a variety of ways. In one embodiment it is provided by means of the control panel 5 or via the infrared receiver 14. A particular combination of keys 4 simultaneously applied may form the pre-determined command. In another embodiment the command is provided by changing jumper settings on a printed circuit board of the television set 1. In another variant a message corresponding to the pre-determined command is received through a network interface (not shown) over a network, such as the Internet. This embodiment is suitable where the pre-determined command is to be kept secret from even the shopkeeper, as the manufacturer can provide the pre-determined command, for example after a buyer of the television set 1 has registered his purchase with the manufacturer.

It should be noted that the above-mentioned embodiments illustrate, rather than limit, the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage. For example, one or more of the input signals corresponding to a desired adjustment of at least one operating parameter of the appliance may be received through a network interface in embodiments in which the television set 1 is comprised in a home network.

1. Apparatus for setting the state of operation of an appliance (1), including
a system (10) for supplying at least one control signal for adjusting an operating parameter of the appliance (1),
a memory device (11) for storing data corresponding to control signal values defining a first state of operation of the appliance (1),
an interface (4,5,14) for receiving at least one input signal corresponding to a desired adjustment of at least one operating parameter of the appliance, and
a controller (10) for converting values of the input signal to at least one value of at least one of the control signals for adjusting an operating parameter of the appliance and for supplying the control signals at the values defining the first state of operation in response to a trigger,
characterized by
including a system for generating the trigger after detecting an absence at the interface (4,5,14) of any input signals corresponding to a desired adjustment of at least one operating parameter of the appliance.

2. Apparatus according to claim 1, wherein the system for generating the trigger includes a timer and is configured to produce the trigger only upon detecting that a time interval length monitored by the timer has exceeded a reference value.

3. Apparatus according to claim 2, configured to re-set the timer to an initial value upon detecting receipt through the interface (4,5,14) of an input signal corresponding to a desired adjustment of at least one operating parameter of the appliance (1).

4. Apparatus according to claim 1, including a control apparatus (5) including at least one component (4) for manipulation by a user and arranged to generate at least one of the input signals corresponding to a desired adjustment of at least one operating parameter of the appliance in accordance with a manipulation of the at least one component by a user.

5. Apparatus according to claim 1, including an interface (4,5,14) for receiving a pre-determined command, wherein the apparatus is configured to disable, in reaction to the pre-determined command, the supply of control signals at the stored values corresponding to the first state of operation in response to the trigger.

6. User-adjustable appliance comprising an apparatus according to claim 1.

7. Method of setting the state of operation of an appliance (1), including
receiving an input signal corresponding to a desired adjustment of at least one operating parameter of the appliance (1),
supplying at least one control signal to at least one component (8,9,10,12,13) of the appliance (1) at respective values obtained by converting values of the received input signal, so as to adjust at least one operating parameter of the appliance (1),
supplying at least one control signal at pre-determined values defining a first state of operation of the appliance to the components (8,9,10,12,13) of the appliance, so as to re-adjust the operating parameters of the appliance, characterized in that
the step of supplying at least one control signal at pre-determined values defining the first state of operation of the appliance is carried out after a time interval commencing at receipt of the input signal corresponding to the desired adjustment, has elapsed.

8. Method according to claim 7, wherein the step of supplying the control signal(s) at pre-determined values is only carried out if no further input signal corresponding to the desired adjustment is received within the time interval.

9. Computer program, including a set of instructions capable, when incorporated in a machine readable medium, of causing a system having information processing capabilities to perform a method according to claim 7.
